(19) United States
(12) Patent Application Publication
(10) Pub. No.: US 2013/0271264 A1
(43) Pub. Date: Oct. 17, 2013

(54) PERSONAL SECURITY SYSTEM

(71) Applicants: Jonathan G. Page, Memphis, TN (US); Jamie A. Horvath, Twinsburg, OH (US); Andrew P. Chick, Nashville, TN (US)

(72) Inventors: Jonathan G. Page, Memphis, TN (US); Jamie A. Horvath, Twinsburg, OH (US); Andrew P. Chick, Nashville, TN (US)

(73) Assignee: Jonathan G. Page, Memphis, TN (US)

(21) Appl. No.: 13/861,043

(22) Filed: Apr. 11, 2013

Related U.S. Application Data
(60) Provisional application No. 61/622,928, filed on Apr. 11, 2012.
(60) Provisional application No. 61/650,610, filed on May 23, 2012.
(60) Provisional application No. 61/772,347, filed on Mar. 4, 2013.

(51) Int. Cl. G08B 1/08

(52) U.S. Cl. CPC G08B 1/08
USPC 340/6.1

(57) ABSTRACT

A personal security system is described herein that includes a mobile electronic device and associated cover. The cover comprises a housing that defines a recess, and an alarm system is disposed within the recess. The cover further includes a triggering mechanism external to the housing, the triggering mechanism being operable to actuate the alarm system in response to user interaction therewith. The alarm system is capable of generating an audible panic alarm in response to user actuation thereof. The alarm system is also capable of wirelessly communicating with the mobile electronic device itself to cause the mobile electronic device to perform additional functions that relate to personal safety when the panic alarm system has been actuated by a user thereof.

### CROSS REFERENCE TO RELATED APPLICATIONS

This application claims priority to U.S. Provisional Application Ser. No. 61/622,928, filed Apr. 11, 2012, U.S. Provisional Application Ser. No. 61/650,610, filed May 23, 2012, and U.S. Provisional Application Ser. No. 61/772,347, filed Mar. 4, 2013. Each of these applications is incorporated herein by reference.

### BACKGROUND

1. Technical Field

The subject matter described herein generally relates to personal security systems.

2. Background Art

According to the Justice Department's Bureau of Justice Statistics, in 2011, United States residents age 12 or older experienced an estimated 5.8 million violent victimizations. Moreover, between 2010 and 2011, the rate of violent victimization increased 17 percent. In addition, one in four college women is physically assaulted at some point during her college career. Given the above statistics, it is only normal for the average person to be concerned about personal safety, especially in environments that are conducive to crime.

A person who is worried about safety may take protective measures, such as informing a friend or family member of his or her whereabouts or even go a step further and be on a telephone call with a friend or family member while being out alone. However, neither of these measures offers the immediate help that is crucial in the event of an attack. For example, if person A is attacked by an aggressor while on the phone with person B, there is a possibility that person B will not recognize that person A is in danger. Furthermore, even if person B became aware of the dangerous situation, person B may not have adequate information, such as the exact location of the person A, to swiftly request help for person A. Moreover, it may be extremely cumbersome for B to contact law authorities in the vicinity of A on behalf of A. For example, if B dials 911, B would be routed to B's local police department, which may not be able to connect B to the police department that is closest to A.

There are conventional panic alarm systems that transmit a silent alarm or emit an audio alarm in response to user activation. However, many of these systems are not portable or are not convenient to use as they are encapsulated in bulky objects, such as backpacks. Some of these alarm systems may be part of dedicated safety devices that the user must always carry around just in case the need arises.

### BRIEF DESCRIPTION OF THE DRAWINGS/FIGURES

The accompanying drawings, which are incorporated herein and form a part of the specification, illustrate the subject matter of the present application and, together with the description, further serve to explain the principles of the embodiments described herein and to enable a person skilled in the pertinent art to make and use such embodiments.

FIG. 1 illustrates the components of a personal security system in accordance with an embodiment.

FIG. 2 is a rear perspective view of a personal security system in accordance with an embodiment.

FIG. 3 is a front perspective view of the personal security system of FIG. 2.

FIG. 4 is an exploded view of the personal security system of FIG. 2 in accordance with an embodiment.

FIG. 5 is a block diagram of an alarm system that comprises part of a mobile electronic device cover in accordance with an embodiment.

FIG. 6 depicts a flowchart of a method of operation of a personal security system in accordance with an embodiment.

FIG. 7 is a rear view of a cover for a mobile electronic device that comprises part of a personal security system in accordance with an embodiment.

FIG. 8 is a rear view of a cover for a mobile electronic device that comprises part of a personal security system in accordance with an embodiment.

FIG. 9 is a rear view of a cover for a mobile electronic device that comprises part of a personal security system in accordance with an embodiment.

FIG. 10 is a rear view of a cover for a mobile electronic device that comprises part of a personal security system in accordance with an embodiment.

FIG. 11 is a rear view of a cover for a mobile electronic device that comprises part of a personal security system in accordance with an embodiment.

FIG. 12 is a rear view of a cover for a mobile electronic device that comprises part of a personal security system in accordance with an embodiment.

FIG. 13 is a rear view of a cover for a mobile electronic device that comprises part of a personal security system in accordance with an embodiment.

FIG. 14 is a rear view of a cover for a mobile electronic device that comprises part of a personal security system in accordance with an embodiment.

FIG. 15 is a rear view of a cover for a mobile electronic device that comprises part of a personal security system in accordance with an embodiment.

FIG. 16 is a rear view of a cover for a mobile electronic device that comprises part of a personal security system in accordance with an embodiment.

FIG. 17 is a block diagram of a processor-based mobile electronic device that may be used to implement various embodiments described herein.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### A. INTRODUCTION

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A personal security system is described herein. In an embodiment, the personal security system includes a protective cover that attaches to a smart phone or other mobile electronic device. A panic alarm system is disposed within the cover. The panic alarm system is capable of generating an audible panic alarm in response to user actuation thereof. For example, the panic alarm system may be capable of generating a very loud (e.g., 90-120 decibel (dB)) panic alarm in response to user actuation thereof.

Smart phones are ubiquitous and are characterized as being useful, convenient, and almost always available to many people. A mobile electronic device cover in accordance with an embodiment is designed to protect both a smart phone and its owner in a convenient and efficient manner. To further elaborate, most smart phone owners would not willingly part with their smart phones even for a short time because smart phones have become very powerful tools with many important functions. In addition, most smart phone owners want to protect their smart phones from wear and tear. A mobile electronic device cover therefore provides an ideal platform for a panic alarm system as many people already carry smart phones and associated smart phone covers with them at all times. As will be made evident by the description provided herein, a mobile electronic device cover that includes a panic alarm system in accordance with an embodiment offers multiple advantages as compared to conventional alarm systems.

In an embodiment, the panic alarm system that is disposed within the mobile electronic device cover is also capable of wirelessly communicating with the mobile electronic device itself to cause the mobile electronic device to perform additional functions that relate to personal safety when the panic alarm system has been actuated by a user thereof. As will be described herein, such functions may include but are not limited to automatically establishing communication (e.g., via a phone call and/or message) with a predetermined person or entity, as well as obtaining location information associated with the mobile electronic device, activating a camera associated with the mobile electronic device to obtain one or more images and/or a video, and activating a microphone associated with the mobile electronic device to capture audio content. Such location information, video/image content, and/or audio content may be transmitted to a person or entity, such as a predetermined person or entity with whom communication has been established using the mobile electronic device.

In certain embodiments, the panic alarm system that is disposed within the mobile electronic device cover is configurable to provide multiple alarm options to a user. For example, in the event of an attack, a very effective response may be to make a lot of noise. However, in certain situations, a silent alarm such as a distress text message to a predetermined person may be preferred over an audible alarm. Still further, other situations may warrant the activation of both an audible alarm and a silent alarm. In an embodiment, the panic alarm system can operate in different modes that may be selected by the user, such as an audible alarm mode, a silent alarm mode, or a combination of audible and silent alarm mode. In accordance with such an embodiment, when the panic alarm system is actuated, the appropriate alarm will be activated according to the selected alarm mode.

Still further embodiments of a personal security system will be described herein, including various features and advantages thereof.

### B. EXAMPLE PERSONAL SECURITY SYSTEM

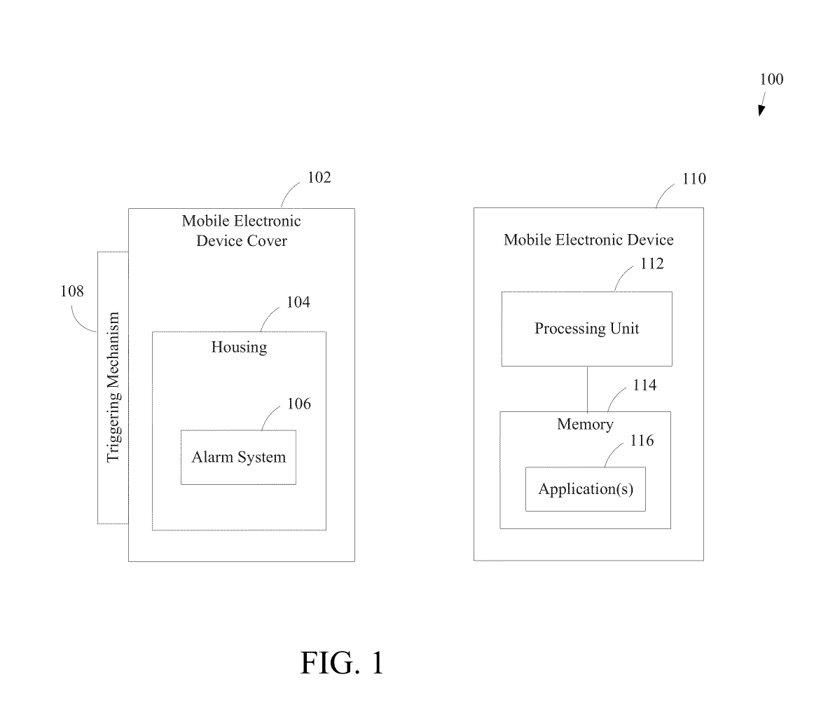

FIG. 1 is block diagram of a personal security system 100 in accordance with an embodiment. As shown in FIG. 1, personal security system 100 includes a mobile electronic device cover 102 that comprises a housing 104, an alarm system 106 disposed within housing 104, and a user-accessible triggering mechanism 108 that is connected to housing 104. Personal security system 100 further includes a mobile electronic device 110 that includes a processing unit 112 and a memory 114. Memory 114 stores one or more software applications 116 that can be executed by processing unit 112. Mobile electronic device cover 102 may be placed on or otherwise attached to mobile electronic device 110.

A user may interact with triggering mechanism 108 to actuate alarm system 106. In an embodiment, actuating alarm system 106 may cause an audible alarm to be generated by alarm system 106. For example, actuating alarm system may cause a very loud (e.g., 90-120 dB) alarm to be generated by alarm system 106. In another embodiment, actuating alarm system 106 may cause other personal security tools to be deployed. Such personal security tool may include chemical deterrents (e.g., pepper spray).

Actuating alarm system 106 may also cause alarm system 106 to wirelessly communicate with mobile electronic device 110. Such wireless communication may cause processing unit 112 to execute one of applications 114. The application, when executed by processing unit 112, may automatically operate to establish communication with at least one predetermined recipient (e.g., by placing a call or sending a distress message to at least one predetermined recipient). Further details regarding the components of personal security system 100 will be provided below.

Mobile electronic device 110 may comprise any sort of electronic device that is capable of being carried by a person. For example and without limitation, mobile electronic device 110 may comprises a mobile or cellular phone including a smart phone (e.g., an iPhone® or a Samsung™ Galaxy), a Blackberry® device, a mobile computer (e.g., a Palm® device), a tablet computer (e.g., an iPad®), a personal digital assistant (PDA), or the like. In some embodiments, mobile electronic device 110 comprises a wireless transceiver that enables mobile electronic device 110 to send messages and/or place or receive telephone calls.

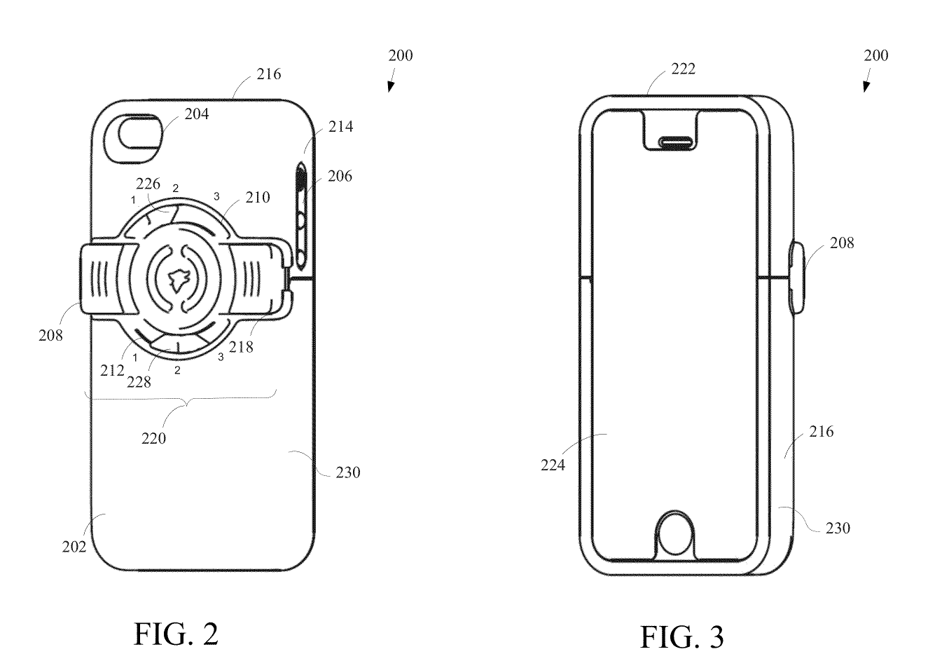

One example implementation of personal security system 100 will now be described in reference to FIGS. 2 and 3. In particular, FIG. 2 illustrates a rear perspective view of a personal security system 200 comprising a mobile electronic device 224 and a mobile electronic device cover 230 that is attached thereto. FIG. 3 is a front perspective view of personal security system 200. Mobile electronic device 224 is one example of mobile electronic device 110 as described above in reference to FIG. 1 and mobile electronic device cover 230 is one example of mobile electronic device cover 102 as described above in reference to FIG. 1.

As shown in FIGS. 2 and 3, mobile electronic device cover 230 includes a housing 216 comprising a front side 222, a back side 202 with aperture 204, and side walls, such as first side wall 214 and second side wall 216. Mobile electronic device cover 230 further includes a triggering mechanism 220, which is one example of triggering mechanism 108 as described above in reference to FIG. 1. In addition, mobile electronic device cover 230 includes a first arcuate switch 210 and a second arcuate switch 212.

As shown in FIG. 2, aperture 204 may provide access to or otherwise accommodate one or more features of mobile electronic device cover 230 or mobile electronic device 224, such as a camera or a light. The side walls of housing 216, which include first side wall 214 and second side wall 216, may completely or partially cover and protect the side walls of mobile electronic device 224. In the embodiment of FIGS. 2 and 3, first side wall 214 includes an aperture 206 that can provide access to or otherwise accommodate one or more features of mobile electronic device cover 230 or mobile electronic device 224, such as one or more volume control buttons. In an embodiment, aperture 206 may expose a charging port operable to accept an adapter for recharging one or more rechargeable batteries of alarm system 106. As further shown in FIGS. 2 and 3, back side 202 and the side walls of housing 216 collectively define a recess that accommodates mobile electronic device 224.

In the embodiment shown in FIGS. 2 and 3, mobile electronic device cover 230 is a case that completely covers at least a back side of mobile electronic device 224. However, in other embodiments, the mobile electronic device cover may comprise a holster that slides over a mobile electronic device and partially or fully covers it. The holster may have a clip for attaching to a belt or other objects. Embodiments described herein may be implemented using still other types of mobile electronic device covers and/or mobile electronic device attachments.

Triggering mechanism 220 comprises a mechanism or device that a user can interact with to actuate an alarm system disposed within mobile electronic device cover 230, such as alarm system 106 as described above in reference to FIG. 1. In the embodiment of FIGS. 2 and 3, triggering mechanism 220 includes a first compressible switch 208 and a second compressible switch 218. Alarm system 106 may be actuated when first compressible switch 208, second compressible switch 218, or both are compressed. The number of switches needed to actuate alarm system 106 may depend on a user-selected operational mode as will be described below. In the embodiment of FIGS. 2 and 3, first compressible switch 208 and second compressible switch 218 comprise mechanical tactile switches. In other example embodiments, triggering mechanism 220 may be formed with other types of switches known in the art.

Furthermore, in certain alternate embodiments, triggering mechanism 220 may be disposed in a portable object other than mobile electronic device cover 230. For example, such a portable object may be a key fob, a necklace, a ring, a watch, or a bracelet that is carried or worn by a user. The triggering mechanism that is incorporated into the portable object may be capable of wirelessly actuating alarm system 106 in mobile electronic device cover 230. Any of a variety of wireless communication protocols may be used to enable such remote triggering of alarm system 106.

Referring back to FIGS. 2 and 3, mobile electronic device cover 230 includes first arcuate switch 210 that comprises an operational mode selection mechanism. In particular, first arcuate switch 210 comprises a three-position switch operable by a user to select a mode of operation of alarm system 106 including off, first active mode, and second active mode. First arcuate switch 210 includes a moveable element 226 that may be moved along an arc of first arcuate switch 210 from one defined position to the next. A user can set first arcuate switch 210 to position 1 (e.g., by moving element 226 to position 1 as shown in FIG. 2) to enter the off mode of alarm system 106. In the off mode, alarm system 106 is in a sleep/standby mode and cannot be actuated. A user can set first arcuate switch 210 to position 2 to enter a first active mode of alarm system 106. In the first active mode, alarm system 106 is active and may be actuated when a user presses either first compressible switch 208 or second compressible switch 218. A user can set arcuate switch 210 to position 3 to enter a second active mode of alarm system 106. In this second active mode, alarm system 106 is active and may be actuated when a user presses both first compressible switch 208 and second compressible switch 218 contemporaneously or at substantially the same time.

As shown in FIG. 2, mobile electronic device cover 230 also includes second arcuate switch 212 that is an alarm mode selection mechanism. In the embodiment of FIGS. 2 and 3, second arcuate switch 212 is a three-position switch operable by a user to select an alarm mode including an audible alarm mode, a silent alarm mode, and a combination alarm mode that is a combination of the audible and silent alarm modes. Second arcuate switch 210 includes a moveable element 228 that may be moved along an arc of second arcuate switch 212 from one defined position to the next. In one embodiment, in addition to selecting the alarm mode with second arcuate switch 212, a user must set first arcuate switch 210 to position 2 or 3 (i.e., the mode of operation need to be on/active) in order to actuate alarm system 106. In any of the selected alarm modes described below, a user may press first compressible switch 208, second compressible switch 218, or both to actuate alarm system 106.

A user can set arcuate switch 212 to position 1 (e.g., by moving button 228 to position 1 as shown in FIG. 2) to enter an audible alarm mode of alarm system 106. When actuated in the audible alarm mode, alarm system 106 generates an audible alarm having a loudness (e.g., around 90 to 120 dB) for a predefined period of time (e.g., one minute). Both the loudness and the period of time may be set at the time of manufacture, configured by a user, or determined by some other means and/or algorithm depending on the embodiment. A user can set arcuate switch 212 to position 2 to enter a silent alarm mode. When actuated in the silent alarm mode, alarm system 106 communicates wirelessly with mobile electronic device 224 to indicate that alarm system 106 has been actuated. A user can set arcuate switch 212 to position 3 to enter a combination alarm mode. The combination alarm mode is a combination of the audible alarm mode and the silent alarm mode. When actuated in the combination alarm mode, alarm system 106 sounds an audible alarm and wirelessly communicates with mobile electronic device 224.

In the embodiment of FIGS. 2 and 3, first arcuate switch 210 and second arcuate switch 212 include position sensors. For example, first arcuate switch 210 and second arcuate switch 212 may each include an array of three omnipolar sensors (e.g., omnipolar Hall-effect sensor integrated circuits) corresponding to positions 1, 2, and 3 of each switch. In such an embodiment, a magnet presenting a field of sufficient strength will cause the switch to change state. For example, when first arcuate switch 210 is set to position 1 corresponding to the off mode of alarm system 106, a sensor corresponding to position 1 turns on because it senses a magnet (i.e., moveable element 226) on top of it. This sensor remains active until first arcuate switch 210 is set to a different position. When first arcuate switch 210 is set to position 2, for example, the sensor corresponding to position 1 turns off and a sensor corresponding to position 2 turns on. In other embodiments, first arcuate switch 210 and second arcuate switch 212 may comprise any other form of commercial or proprietary mechanical, electrical, electronic, or optical switching devices.

Persons skilled in the relevant art(s) will appreciate that first compressible switch 208, second compressible switch 218, first arcuate switch 210, and second arcuate switch 212 on mobile electronic device cover 230 may be configured in a manner that is different from that described above. For example, the various user-selectable positions of first arcuate switch 210 and second arcuate switch 212 may be configured/programmed to correspond to different alarm modes and/or operational modes than those described above and some positions may be unused. Additional switches or buttons may be added to mobile electronic device cover 230 to provide additional features (e.g., a button that can send a wireless signal to mobile electronic device 224). In embodiments, an alarm mode selection mechanism (e.g., second arcuate switch 212) and/or an operational mode selection mechanism (e.g., first arcuate switch 210) may be integrated together or with triggering mechanism 220. Furthermore, the alarm modes and operational modes may be redefined.

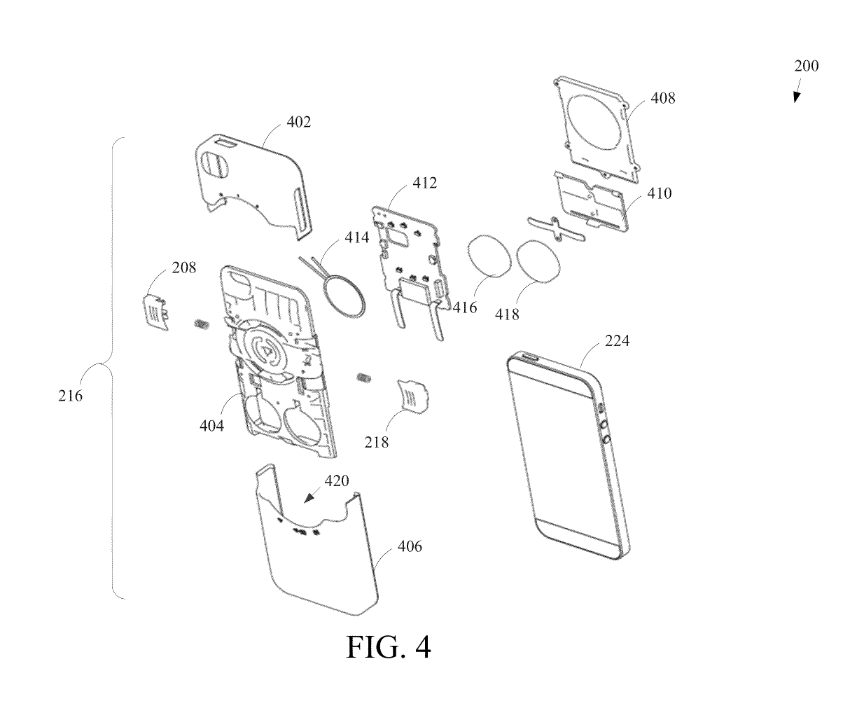

Mobile electronic device cover 230 includes internal components, some of which are illustrated in FIG. 4. In particular, FIG. 4 is an exploded view of security system 200. As shown in FIG. 4, housing 216 includes a top casing 402, an electronic housing 404, a bottom casing 406, an electronic housing cap 408, and a battery door 410. Housing 216 may be assembled in the following manner. Electronic housing 404 is irremovably affixed to bottom casing 406. Top casing 402 is removably attached to bottom casing 406 and/or electronic housing 404. For example, top casing 402 may be removed to allow mobile electronic device 224 to be placed into mobile electronic device cover 230. Once mobile electronic device 224 is positioned inside bottom casing 406, top casing 402 may be reattached to bottom casing 406 and/or electronic housing 404. Electronic housing cap 408 may be irremovably affixed (e.g., with screws) to electronic housing 404. Battery door 410 may be removably attached to electronic housing 404 and/or bottom casing 406. Battery door 410 may be removed to facilitate replacement of batteries of alarm system 106.

As shown in FIG. 4, electronic housing 404 provides protection for alarm system 106, which may be disposed within a recess 420 formed at least by bottom casing 406 and top casing 402. In the embodiment shown in FIG. 4, alarm system 106 includes a circuit board 412, a piezoelectric (piezo) alarm 414, a first battery 416, and a second battery 418. Alarm system 106 may include other circuitry and/or components such as but not limited to one or more transformers, inverters, capacitors, resistors, diodes, inductors, transistors, multiplexers, demultiplexers, connectors, and battery holders. Circuit board 412 provides mechanical support and electrical connection for the electronic components of alarm system 106. Circuit board 412 may comprise a printed circuit board and may include one or more electrical circuits that provide functionality for alarm system 106, including computing/processing circuits, logical circuits, electromechanical circuits, communications circuits, or the like.

Piezo alarm 414 shown in FIG. 4 is a component that is mounted on circuit board 412. Piezo alarm 414 is used for generating an audible alarm in response to actuation of alarm system 106 by a user. Piezo alarm 414 may comprise a commercially-available alarm or a proprietary alarm. In embodiments, audio signaling devices (e.g., mechanical or electromechanical devices) other than a piezo alarm may be used to generate the audible alarm for alarm system 106.

As shown in FIG. 4, first battery 416 and second battery 418 may be used to provide power to alarm system 106. Batteries 416 and 418 may be user-replaceable batteries. Alternatively, batteries 416 and 418 may be rechargeable batteries, which may be charged with an adapter via a charging port that is accessible through an aperture (e.g., aperture 206 shown in FIG. 2) in housing 216. Although two thin batteries are shown in FIG. 4, any other types of battery and number of batteries may be used if they sufficiently provide power for alarm system 106.

In an implementation, the components of alarm system 106 are miniaturized and stacked flatly such that the total thickness of mobile electronic device cover 230 is no more than ⅜ of an inch. In accordance with such implementation, the components are all embedded into housing 216, and to an ordinary person, mobile electronic device cover 230 would appear to be about ⅜ of an inch. Persons skilled in the relevant art(s) would appreciate that other sizes and arrangement of the components of alarm system 106 may be used. Likewise, other thicknesses of mobile electronic device cover 230 may be achieved.

In the embodiments of FIGS. 1-4, a panic alarm system is disposed within a mobile electronic device cover that is separate from, and attachable to, a mobile electronic device. In alternate embodiments, the panic alarm system may be directly integrated or incorporated with a mobile electronic device. In accordance with such embodiments, the alarm system may be actuated by using features of the mobile electronic device (e.g., voice command or sequence of buttons) or by triggering an external triggering mechanism on the housing of the mobile electronic device. The activation of the alarm system may cause an audible alarm to be sounded by the mobile electronic device (e.g., features of the mobile electronic device are used to generate the audible alarm). Furthermore, the activation of the alarm system may cause an application to be executed on the mobile electronic device that causes distress messages to be sent therefrom. In accordance with these embodiments, the communication between the alarm system and the mobile electronic device may be carried out using a wired connection since the alarm system is integrated with the mobile electronic device. However, a wireless connection could still be used. In other embodiments, the panic alarm system may be a separate unit that may be attached to a mobile electronic device. For example, the panic alarm system may be a device that is electronically connected to the mobile electronic device via an external port (e.g., a dongle that is connected to a phone via an audio jack or a Universal Serial Bus port).

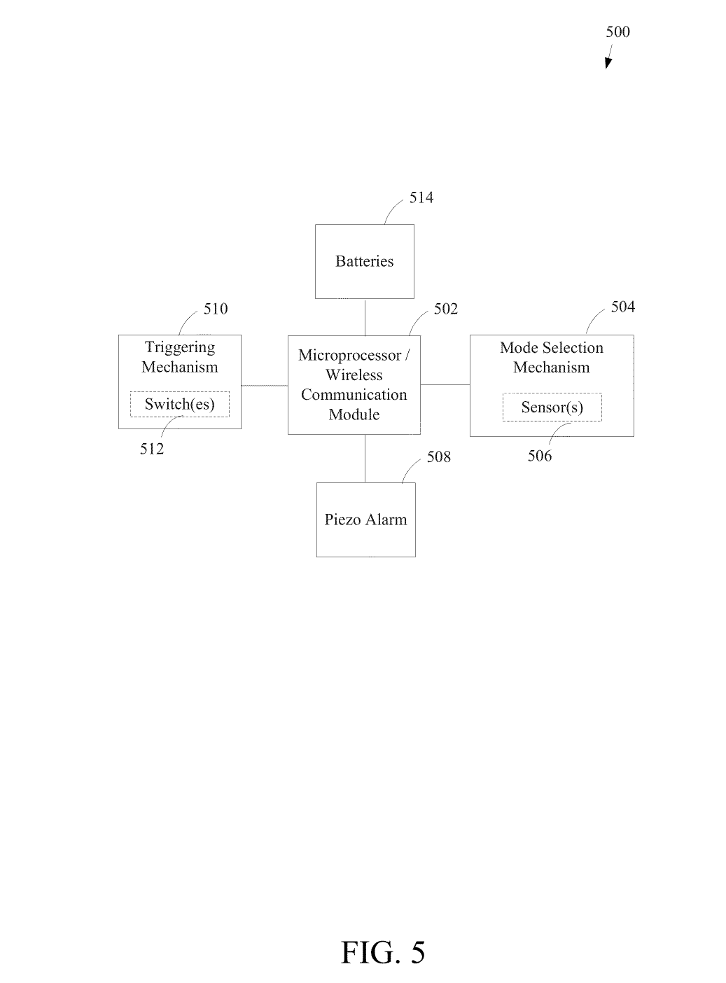

FIG. 5 is a block diagram of an alarm system 500, which is one example of alarm system 106 as described above in reference to FIG. 1. As shown in FIG. 5, alarm system 500 includes a microprocessor/wireless communication module 502, a mode selection mechanism 504, a piezo alarm 508, a triggering mechanism 510, and batteries 514. In an implementation, piezo alarm 508 is one example of piezo alarm 414, and batteries 514 are examples of batteries 416 and 416 as described above in reference to FIG. 3.

Mode selection mechanism 504 is one example of an alarm mode selection mechanism (e.g., second arcuate switch 212) and an operational mode selection mechanism (e.g., first arcuate switch 210) such as was described above in reference to FIGS. 2-4. Mode selection mechanism 504 includes one or more sensors 506. In an implementation, sensors 506 may be position sensors as described above in reference to FIGS. 2-4. Triggering mechanism 510 is an example of triggering mechanism 108 shown in FIG. 1 or triggering mechanism 220 shown in FIG. 2. Triggering mechanism 510 includes one or more switches 512. In an implementation, switches 512 may be mechanical tactile switches, such as first compressible switch 208 and second compressible switch 218 as described above in reference to FIGS. 2-4.

Similar to alarm system 106, alarm system 500 is configured to wirelessly communicate with a mobile device, such as mobile device 224 shown in FIG. 3, in response to user interaction with triggering mechanism 510. In an embodiment, when the operational mode of is set to off, alarm system 500 will not activate even if triggering mechanism 510 is activated by a user. This prevents alarm system 500 from being accidentally triggered.

In an example embodiment, alarm system 500 is generally in a standby or sleep mode, waiting for user interaction with triggering mechanism 510 to occur. In such embodiment, when a user interacts with triggering mechanism 510 by activating one or more of switches 512, microprocessor/wireless communication module 502 would perform the action dictated by the operational mode and the alarm mode selected by the user. In order to determine the operational mode and the alarm mode, microprocessor/wireless communication module 502 may monitor sensors 506, each of which may correspond to an alarm mode or an operational mode. For example, when microprocessor/wireless communication module 502 determines that one of switches 512 has been activated, one of sensors 506 corresponding to a first active operational mode is active, and one of sensors 506 corresponding to an audible alarm mode is active, microprocessor/wireless communication module 502 may send a signal to piezo alarm 508 to activate an audible alarm. In another example, when microprocessor/wireless communication module 502 determines that two of switches 512 have been activated, one of sensors 506 corresponding to a second active operation mode is active, and one of sensors 506 corresponding to a combination alarm mode is active, microprocessor/wireless communication module 502 may send a signal to piezo alarm 508 to activate an audible alarm as well as a signal to a mobile electronic device, such as mobile electronic device 224 as described above in reference to FIGS. 2-4, to indicate that alarm system 500 has been actuated.

The operation of alarm system 500 according to the different operational modes, alarm modes, and user interaction of triggering mechanism 510 is summarized in Table 1 below for the embodiment of FIG. 5. All steps may be performed by microprocessor/wireless communication module 502. For this embodiment as shown in Table 1, switches 512 comprise switch 1 and switch 2 and sensors 506 comprise six sensors, three of which relate to the alarm modes (e.g., audible sensor, silent sensors, and combination sensor) and the remaining three relate to the operation modes (e.g., off mode sensor, first active mode sensor, second active mode sensor).

TABLE 1
Operation of Alarm System 500

| | Off | | |
|---|---|---|---|
| | Mode | | |
| | Sensor | | 2^{nd} Active |
| | On | 1^{st} Active Mode Sensor On | Mode Sensor On |
| Switches 1 | Standby | Standby | Standby |
| and 2 Off | | | |
| Switch 1 | Standby | Determine that audible | Standby |
| on | | sensor is active, send a | |
| | | signal to piezo alarm 508 | |
| | | Determine that silent sensor | |
| | | is active, send a signal to | |
| | | mobile electronic device | |
| | | Determine that combination | |
| | | sensor is active, send signal | |
| | | to piezo alarm 508 and | |
| | | mobile electronic device | |
| Switch 2 | Standby | Determine that audible | Standby |
| on | | sensor is active, send a | |
| | | signal to piezo alarm 508 | |
| | | Determine that silent sensor | |
| | | is active, send a signal to | |
| | | mobile electronic device | |
| | | Determine that combination | |
| | | sensor is active, send signal | |
| | | to piezo alarm 508 and | |
| | | mobile electronic device | |
| Switch 1 | Standby | Standby | Determine that audible |
| and | | | sensor is active, send a |
| Switch 2 | | | signal to piezo |
| are both | | | alarm 508 |
| on | | | Determine that silent |
| | | | sensor is active, send a |
| | | | signal to mobile |
| | | | electronic device |
| | | | Determine that |
| | | | combination sensor is |
| | | | active, send signal to |
| | | | piezo alarm 508 and |
| | | | mobile electronic |
| | | | device |

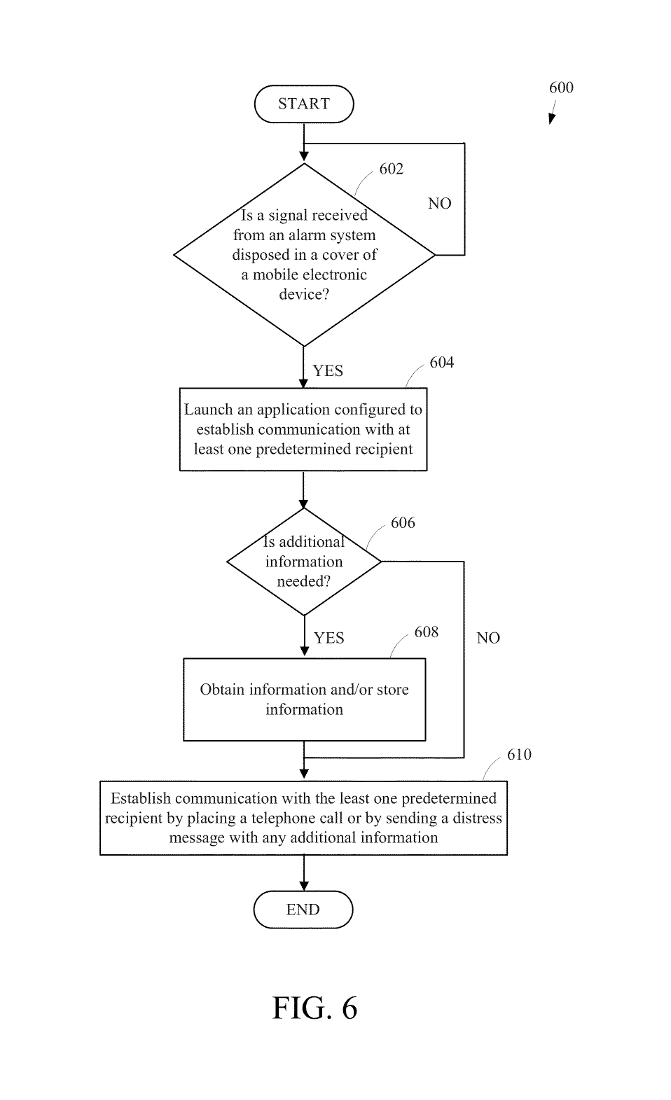

FIG. 6 depicts a flowchart 600 of a method that may be carried out by a processing unit of a mobile electronic device in accordance with an embodiment. For example, the process of flowchart 600 may be performed by an application (e.g., one of applications 114) executed by processing unit 112 of mobile electronic device 110 as described above in reference to FIG. 1. The method of flowchart 600 is described as follows. Note that the steps of flowchart 600 can be performed in an order different than shown in FIG. 6 in some embodiments. Furthermore, not all steps of flowchart 600 need to be performed in all embodiments. Further structural and operational embodiments will be apparent to persons skilled in the relevant art(s) based on the following description.

The method of flowchart 600 begins with decision step 602. In decision step 602, it is determined whether a signal has been received from an alarm system disposed in a cover of a mobile electronic device. For example, in an embodiment, it is determined whether a wireless signal has been received from alarm system 500, which may be disposed in cover 230 of device 224 as shown in FIGS. 2-3. Such a signal may be generated in response to a determination by alarm system 500 that one or more of first compressible switch 208 and second compressible switch 218, as described above in reference to FIG. 2, has been compressed. In particular, the signal may be generated by microprocessor/wireless communication module 502. In an implementation, microprocessor/wireless communication module 502 comprises a Bluetooth® network module that includes a processor and a Bluetooth® transmitter. In another implementation, microprocessor/wireless communication module 502 comprises a Near Field Communication (NFC) transmitter and a processor. In other embodiments, wireless communication between alarm system 500 and mobile electronic device 224 may be achieved using any other wireless communication technologies and protocols known in the art. Examples of wireless networks over which the signal from alarm system 400 may be transmitted includes ZigBee®, TransferJet™, Personal Area Networks (PAN), Local Area Networks (LAN), Wireless Metropolitan Area Network (WMAN). For example and without limitation, NFC, Radio-Frequency Identification (RFID), and other similar short-range communication technologies may be used. Still other wireless communication technologies and protocols may be used, whether such technologies and protocols presently exist or are subsequently developed.

If it is determined during decision step 602 that no signal has been received then the processing unit/application simply continues to wait for a signal before advancing to the next step. However, if it is determined during decision step 602 that a wireless signal is received from alarm system 500, then the method of flowchart 600 continues with step 604.

In step 604, an application configured to establish communication with at least one predetermined recipient is launched. The predetermined recipient may include a person, an entity, a call center, a central monitoring station, or the like. For example, the predetermined recipient may be a family member, a university, a corporation, a particular police department or a police department that is closest to the user. In another example, the recipient may be selected in real time rather than preselected. In an embodiment, in response to receiving a wireless signal from alarm system 500, one of applications 114 shown in FIG.1 is launched. In another embodiment, the application for establishing communication with a predetermined recipient may always be active to monitor for the wireless signal from alarm system 500, and thus step 604 may not be necessary.

The application being launched for establishing communication with a predetermined recipient may be implemented in various manners. In an implementation, the application being launched may be a voice application configured to place a telephone call to predetermined recipient(s) on a call list. The call list may include preprogrammed recipient(s) or contact(s) selected by the user. The call list may be configured by a user, an entity, a script, or other means known to persons skilled in the relevant art(s). In another implementation, the application being launched may be a messaging application configured to send a distress message to predetermined recipient(s) on a message list. The message list may include preprogram recipient(s) or contact(s) selected by the user. The message list may be configured by a user, an entity, a script, or other means known to persons skilled in the relevant art(s). The message list may be the same or different from the call list. The messaging application may include an application that is configured to send any form of a distress message. Examples of the distress message include a Short Message Service (SMS) text message, a Multimedia Messaging Service (MMS) multimedia message (e.g., videos), an electronic mail message, an instant/chat message sent through Apple Messages® for example, a message sent through an SMS or MMS gateway, or another similar system for message transmission. In yet another implementation, the application being launched may be an alarm system application configured to perform a series of steps in response to receiving a signal from alarm system 500, such as placing a telephone call, sending a distress message, or both in the same or similar manner as described above in reference to the dedicated voice or messaging application. Alternatively, the alarm system application may be configured to facilitate the launching of other application(s) to perform the series of steps.

The method of flowchart 600 continues with decision step 606. In decision step 606, a determination is made whether additional information is needed. In an implementation, this determination is made by the alarm system application as described above in reference to step 604. The type and extent of additional information that is needed or desired, if any, may be predetermined by the user. For example, the user may configure the settings of the application launched in step 604 when the user first placed mobile electronic device cover 230 on mobile electronic device 224.

If it is determined during decision step 606 that additional information is needed, then the method proceeds to step 608; otherwise, the method proceeds to step 610. In step 608, information associated with the mobile electronic device, information that relates to a user of the mobile electronic device, or information that relates to an environment of the user of the mobile electronic device may be obtained. Additionally or alternatively, information associated with the mobile electronic device, information that relates to a user of the mobile electronic device, or information that relates to an environment of the user of the mobile electronic device may be stored.

For example, information associated with the mobile electronic device may include location information. In an embodiment, the location information that may be obtained includes Global Position System (GPS) coordinates of mobile electronic device 110 as shown in FIG. 1. In other embodiments, the location information may be obtained using other positioning systems, including a cellular-based positioning system, a WLAN (wireless local area network) based positioning system, or a hybrid positioning system. In these embodiments, the location information may be obtained by a positioning module of mobile electronic device 110. Information that relates to a user of the mobile electronic device may include a recording of the user's voice or a photographic image of the user. Information that relates to an environment of the user may include a video recording of the user and the user's situation.

In step 608, a positioning module, a camera and/or microphone may be activated to determine location or facilitate live-streaming of sound or video footage of the user's situation. Alternatively, such information may be captured and sent in non-real time. In an implementation, the application launched in step 604, such as the alarm system application, may be configured to perform any of the sub-steps of step 608. Alternatively, the alarm system application may be configured to facilitate the launching of other application(s) to perform the sub-steps. Even if not explicitly set forth herein, other information that may be helpful to locate the user or determine the user's situation may be obtained and transmitted to a recipient in real-time or stored for later transmission to a recipient.

In step 610, communication is established with the at least one predetermined recipient by placing a telephone call or by sending a distress message with any additional information. For example, in an embodiment, an application launched in step 604 may be used to establish communication with the at least one predetermined recipient. Establishing communication may include placing a telephone call to contacts selected by the user on a call list or sending a distress message to contacts selected by the user on a message list as described above in reference to step 604 of flowchart 600. In such embodiment, the distress message may include information gathered during step 608. For example, the distress message may include GPS coordinates or other information relating to the position of the mobile electronic device, such as device 110 shown in FIG. 1. Additionally or optionally, the distress message may include images or video footage of the user's situation. In another embodiment, in response to receiving a wireless signal from alarm system 500, actions different from the ones set forth in steps 604 and/or 608 may be performed. For example, an action may be to periodically obtain, store, and/or transmit information relating to a user for a period of time or until a notice to cease such action is received. Another action may be to collect and transmit information regarding physical evidence (e.g., finger print, blood type, or fiber type/presence) to a recipient.

### C. OTHER EXAMPLE EMBODIMENTS OF TRIGGERING MECHANISM, OPERATIONAL MODE SELECTION MECHANISM, AND ALARM MODE SELECTION MECHANISM

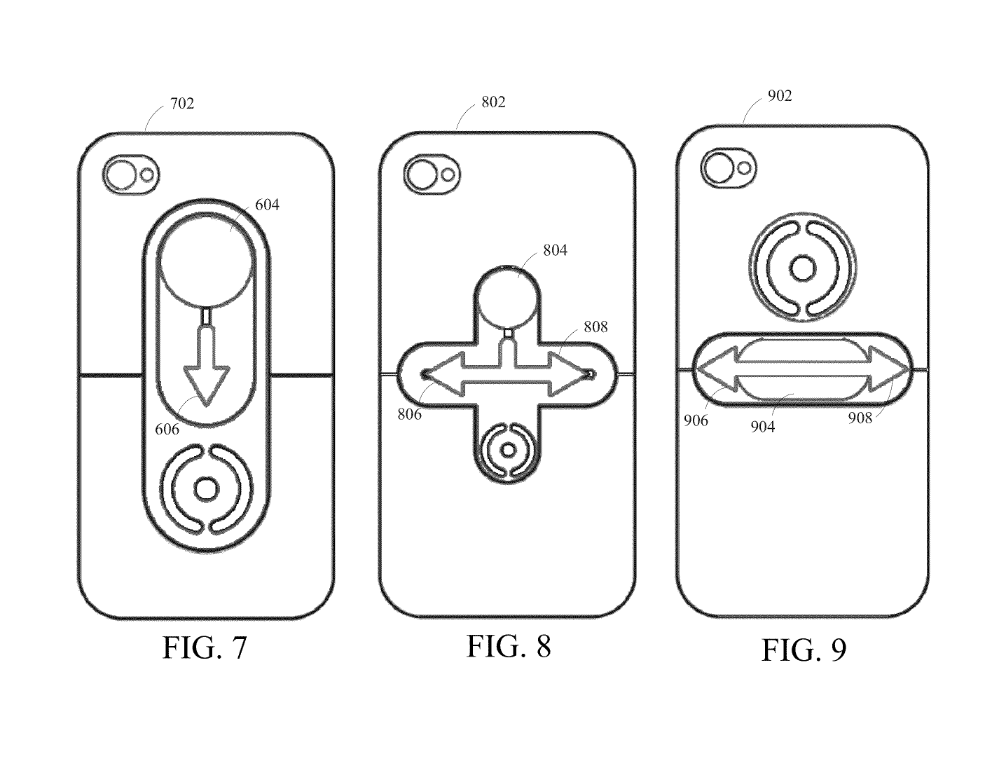

FIGS. 7-16 illustrate examples embodiments of a mobile electronic device cover, such as mobile electronic device cover 230 as described above in reference to FIGS. 2-3 or mobile electronic device cover 102 described above in reference to FIG. 1. There are numerous ways to implement the mobile electronic device cover, especially with respect to the triggering mechanism (e.g., triggering mechanism 220 shown in FIG. 2), the operational mode selection mechanism (e.g., first arcuate switch 210 shown in FIG. 2), and the alarm mode selection mechanism (e.g., second arcuate switch 212 shown in FIG. 2). In some implementations, these mechanisms are separate from each other. In other implementations, these mechanisms may be combined and/or integrated with one another in various manners as will be described below.

FIG. 7 is a rear view of one example embodiment of a mobile electronic device cover 702 that includes a sliding button. In particular, as shown in FIG. 7, mobile electronic device cover 702 includes a sliding button 704 that is paired with a momentary or pressure sensitive switch. Sliding button 704 is a single spring loaded button that slides on a vertical axis. Sliding button 704 must be held down for a predetermined amount of time (e.g., 3 seconds) to trigger an alarm system, such as alarm system 106. In this embodiment, the alarm mode selection is managed through an application, such as one of application(s) 114 on mobile electronic device 110 as described above in reference to FIG. 1. When the application is not running, sliding button 704 may be momentarily pulled in the direction of arrow 706 to trigger an audible alarm, which may be generated by alarm system 106 with piezo alarm 414 as described above in reference to FIG. 4 for example.

FIG. 8 is a rear view of another example of a mobile electronic device cover 802 that includes a sliding button. In particular, mobile electronic device cover 802 shown in FIG. 8 includes a sliding button 804. Sliding button 804 may be slid along a tortuous path in the direction of arrow 806 or arrow 808 to actuate an alarm system, such as alarm system 106. To set the alarm mode, sliding button 804 may be slid along one direction (e.g., along arrow 806 or 808) to generate an audible alarm briefly and sliding button 804 may be slid along the other direction (e.g., along arrow 806 or 808) to generate the audible alarm for a longer period of time.

FIG. 9 is a rear view of yet another example of a mobile electronic device cover 902 that includes a sliding button. In particular, mobile electronic device 902 shown in FIG. 9 includes a single sliding button 904. Sliding button 904 may be slid along a tortuous path in the direction of arrow 906 or arrow 908 to actuate an alarm system, such as alarm system 106. To set the alarm mode, sliding button 904 may be slid along one direction (e.g., along arrow 906 or 908) to generate an audible alarm briefly and sliding button 904 may be slid along the other direction (e.g., along arrow 906 or 908) to generate the audible alarm for a longer period of time. In this embodiment, the alarm mode selection is managed through an application, such as one of application(s) 114 on mobile electronic device 110 as in reference to FIG. 1. Additionally or alternatively, the alarm mode may be selected using volume controls associated with mobile electronic device 110.

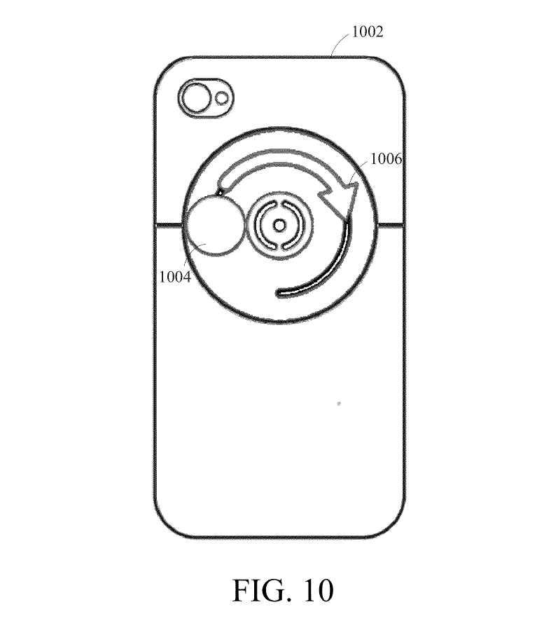

FIG. 10 is a rear view of an example embodiment of a mobile electronic device cover 1002 that includes a rotating button 1004 that is paired with a momentary or pressure sensitive switch. Rotating button 1004 may be slid along a circular path in the direction of arrow 1006 to actuate an alarm system, such as alarm system 106. To set the alarm mode, rotating button 1004 may be rotated past 180° to generate an audible alarm briefly and rotating button 1004 may be rotated to 270° to generate an audible alarm for a longer period of time.

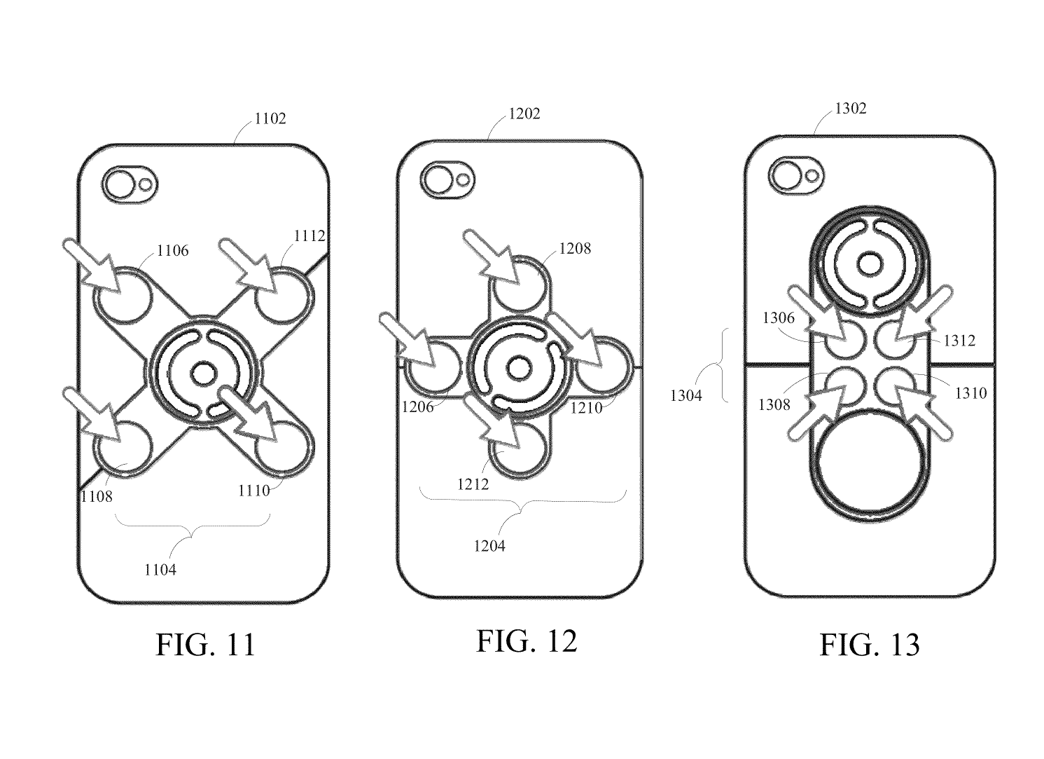

FIG. 11 is a rear view of an example embodiment of a mobile electronic device cover that includes a four button keypad. In particular, as shown in FIG. 11, mobile electronic device cover 1102 includes a keypad 1104 comprising buttons 1106, 1108, 1110 and 1112. A combination of these buttons may be depressed within a certain time frame to actuate an alarm system, such as alarm system 106. The alarm mode is selected based on the number of buttons that are depressed. For example, if two of the buttons are depressed a silent alarm is activated, if three of the buttons are depressed, an audible alarm is activated. The user may determine the alarm mode (e.g., silent, audible, manual) on the fly.

FIG. 12 is a rear view of another example embodiment of a mobile electronic device cover 1202 that includes a four button keypad. As shown in FIG. 12, mobile electronic device cover 1202 includes a keypad 1204 comprising buttons 1206, 1208, 1210 and 1214. A combination of these buttons may be depressed within a certain time frame to actuate an alarm system, such as alarm system 106. The alarm mode is selected based on the number of buttons that are depressed. For example, if two of the buttons are depressed a silent alarm is activated, if three of the buttons are depressed, an audible alarm is activated. The user may determine the alarm mode (e.g., silent, audible, manual) on the fly. In addition, light emitting diodes (LEDs) may be used in this embodiment to illuminate a cross shape as a signal for help.

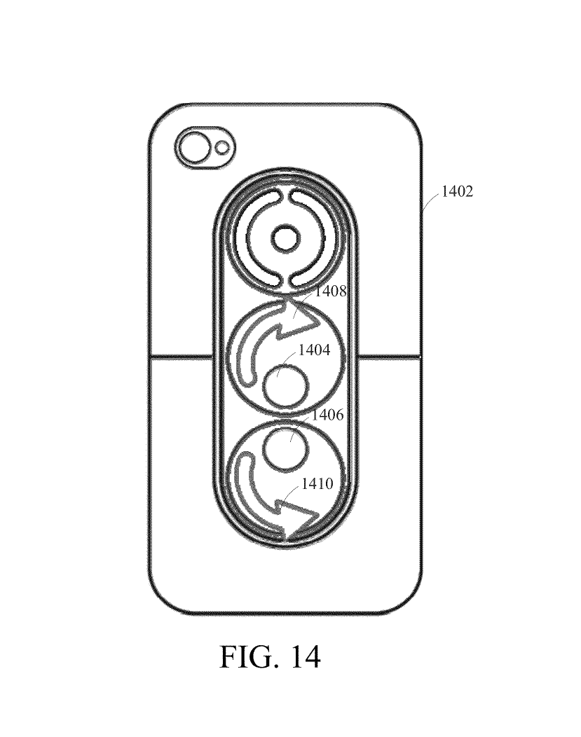

FIG. 13 is a rear view of yet another example embodiment of a mobile electronic device cover 1302 that includes a four button keypad. As shown in FIG. 13, cover 1302 includes a keypad 1304 comprising buttons 1306, 1308, 1310 and 1312. A combination of these buttons may be depressed within a certain time frame to actuate an alarm system, such as alarm system 106. The alarm mode is selected based on the number of buttons that are depressed. For example, if two of the buttons are depressed a silent alarm is activated, if three of the buttons are depressed, an audible alarm is activated. In this embodiment, alarm system 106 may be implemented as a removable module.

FIG. 14 is a rear view of an example embodiment of a mobile electronic device cover 1402 that includes counter rotating switches. As shown in FIG. 14, mobile electronic device cover 1402 includes a first button 1404 that is associated with a first rotating switch and a second button 1406 that is associated with a second rotating switch. First button 1404 and second button 1406 may be rotated in opposite directions as shown by arrows 1408 and 1410, respectively, to actuate an alarm system, such as alarm system 106. This embodiment provides flexibility as to how the rotating switches may be configured. This embodiment is also mechanically simple to implement. For example, second button 1406 may include a battery contact underneath to facilitate the manual generation of an audible alarm when second button 1406 is rotated.

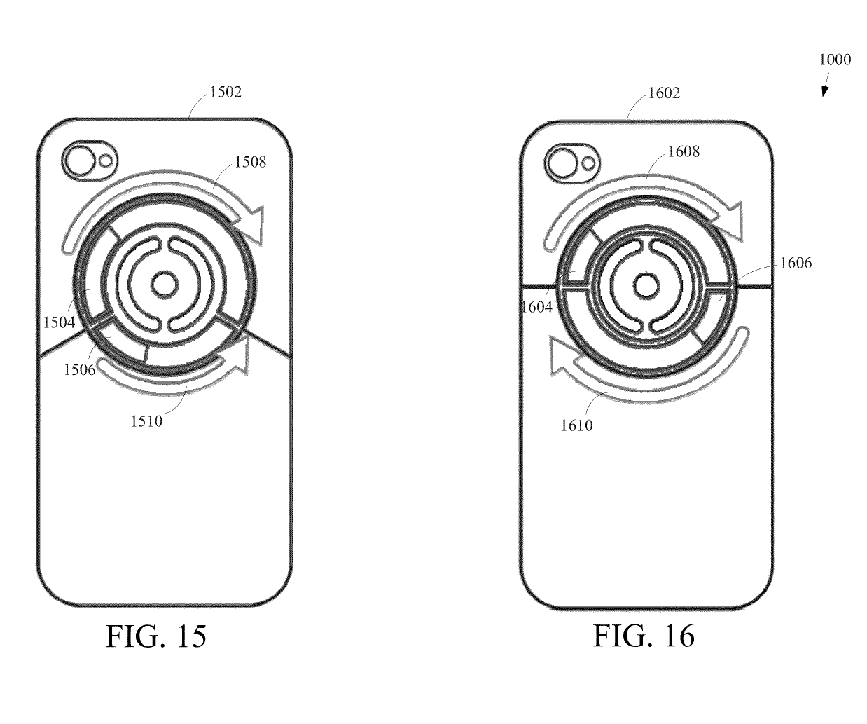

FIG. 15 is a rear view of an example embodiment of a mobile electronic device cover 1502 that includes a rotating switch 1504 and a three-position switch 1506. In another embodiment, switch 1504 is the three-position switch and switch 1506 is the rotating switch. In either embodiment of mobile electronic cover 1502, the rotating switch may be rotated in the direction of the corresponding arrow, i.e., arrow 1508 for switch 1504 and arrow 1510 for switch 1506, to actuate an alarm system, such as alarm system 106. To set the alarm mode, the three-position switch may be slid to the predetermined positions that correspond to the alarm modes (e.g., manual, silent, audible).

FIG. 16 is a rear view of another example embodiment of a mobile electronic device cover 1602 that includes a rotating switch 1604 and a three-position switch 1606. In another embodiment, switch 1604 is the three-position switch and switch 1606 is the rotating switch. In either embodiment of mobile electronic device cover 1602, the rotating switch may be rotated in the direction of the corresponding arrow, i.e., arrow 1608 for switch 1604 and arrow 1620 for switch 1606, to actuate an alarm system, such as alarm system 106. To set the alarm mode, the three position switch may be slid to predetermined positions that correspond to the alarm modes (e.g., manual, silent, audible).

### D. EXAMPLE MOBILE ELECTRONIC DEVICE IMPLEMENTATION

The features of mobile electronic device 110 and mobile electronic device 224 may be implemented in hardware (e.g., hardware logic/electrical circuitry), or any combination of hardware with software (computer program code configured to be executed in one or more processors or processing devices) and/or firmware.

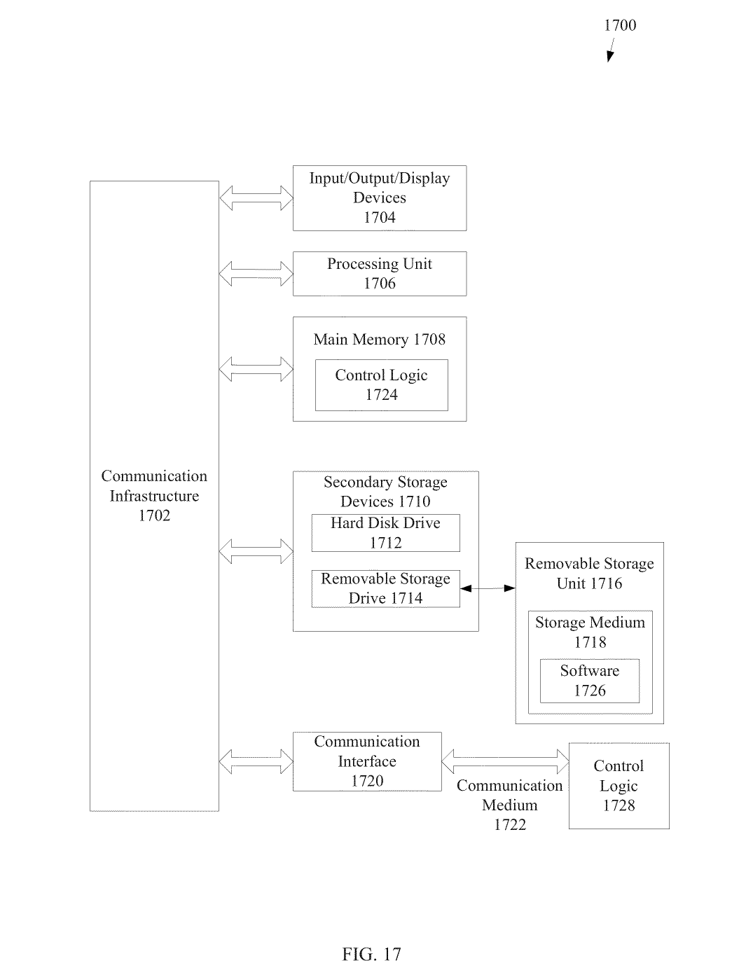

FIG. 17 is a block diagram of a processor-based system 1700 that may be used to implement mobile electronic device 110 or mobile electronic device 224. As shown in FIG. 17, system 1700 includes a processing unit 1706. Processing unit 1706 may comprise one or more processors (also called central processing units or CPUs) or processor cores. Processing unit 1706 is connected to a communication infrastructure 1702, such as a communication bus. System 1700 also includes a primary or main memory 1708, such as random access memory (RAM). Main memory 1708 has stored therein control logic 1724 (computer software), and data.

System 1700 may also include one or more secondary storage devices 1710, including, for example, a hard disk drive 1712 and/or a removable storage device or drive 1714. System 1700 may also include other types of storage devices, such as memory cards and memory sticks. For instance, system 1700 may include an industry standard interface, such as a universal bus (USB) interface for interfacing with devices such as a memory stick. Removable storage drive 1714 represents a floppy disk drive, a magnetic tape drive, a compact disk drive, an optical storage device, tape backup, etc.

Removable storage drive 1714 interacts with a removable storage unit 1716. Removable storage unit 1716 includes a computer useable or readable storage medium 1718 having stored therein computer software 1726 (control logic) and/or data. Removable storage unit 1716 represents a floppy disk, magnetic tape, compact disk, DVD, optical storage disk, or any other computer data storage device. Removable storage drive 1714 reads from and/or writes to removable storage unit 1716 in a well-known manner.

System 1700 also includes input/output/display devices 1704, such as touchscreens, LED and LCD displays, keypads, etc.

System 1700 further includes a communication or network interface 1720. Communication interface 1720 enables system 1700 to communicate with remote devices. For example, communication interface 1720 allows system 1700 to communicate over communication networks or medium 1722 (representing a form of a computer usable or readable medium), such as LANs, WANs, the Internet, etc. Network interface 1720 may interface with remote sites or networks via wired or wireless connections.

Control logic 1728 may be transmitted to and from system 1700 via communication medium 1712.

Any apparatus or manufacture comprising a computer usable or readable medium having control logic (software) stored therein is referred to herein as a computer program product or program storage device. This includes, but is not limited to, system 1700, main memory 1708, secondary storage devices 1710, and removable storage unit 1716. Such computer program products, having control logic stored therein, may be executed by processing unit 1106 to perform methods described herein. For example, such computer program products, when executed by processing unit 1106, may cause processing unit to perform any of the steps of flowchart 600 of FIG. 6.

### E. CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A cover for a mobile electronic device, comprising:
a housing, the housing defining a recess;
an alarm system disposed within the recess; and
a triggering mechanism external to the housing, the triggering mechanism being operable to actuate the alarm system in response to user interaction therewith.

2. The cover of claim 1, wherein the housing comprises one of:
a holster that slides over the mobile electronic device and partially covers the mobile electronic device; and
a case that completely covers at least one side of the mobile electronic device.

3. The cover of claim 1, wherein the alarm system comprises a transmitter that is operable to wirelessly communicate with the mobile electronic device in response to actuation of the alarm system.

4. The cover of claim 1, wherein the alarm system comprises a piezoelectric alarm that generates an audible alarm in response to actuation of the alarm system.

5. The cover of claim 1, wherein the alarm system comprises one or more user-replaceable batteries.

6. The cover of claim 1, wherein the alarm system comprises one or more rechargeable batteries and a charging port operable to accept an adapter for recharging the one or more rechargeable batteries, the charging port being accessible via an aperture in the housing.

7. The cover of claim 1, wherein the trigging mechanism comprises at least one of a sliding button, a rotating button, a keypad, a rotating switch, a three-position switch, or a pair of compressible buttons.

8. The cover of claim 1, further comprising an alarm mode selection mechanism external to the housing.

9. The cover of claim 8, wherein the alarm mode selection mechanism is integrated with the triggering mechanism.

10. The cover of claim 1, wherein the housing is integrated into a housing of the mobile electronic device.

11. A computer program product comprising a computer readable medium having computer program logic recorded thereon for enabling a processing unit of a mobile electronic device to perform operations, the computer program logic comprising:
first means for causing the processing unit to receive a signal from a panic alarm system disposed in a cover of the mobile electronic device; and
second means for causing the processing unit to establish communication with at least one predetermined recipient in response to receiving the signal from the panic alarm system.

12. The computer program product of claim 11, wherein the second means comprises means for causing the processing unit to launch an application on the mobile electronic device, the application being configured to establish communication with the at least one predetermined recipient in response to receiving the signal from the panic alarm system.

13. The computer program product of claim 11, wherein the second means comprises means for causing the processing unit to place a telephone call to the at least one predetermined recipient.

14. The computer program product of claim 11, wherein the second means comprises means for causing the processing unit to send a message to the at least one predetermined recipient.

15. The computer program product of claim 14, wherein the message comprises at least one of a short message service (SMS) text message, a multimedia messaging service (MMS) multimedia message, an electronic mail message, a chat message, or a message transmitted via an SMS gateway, an MMS gateway, or other message transmission system.

16. The computer program product of claim 11, wherein the computer program logic further comprises third means for causing the processing unit to perform, in response to receiving the signal from the personal panic alarm system, at least one of:
obtaining one or more of information associated with the mobile electronic device, information that relates to a user of the mobile electronic device, or information that relates to an environment of the user of the mobile electronic device; and
storing one or more of information associated with the mobile electronic device, information relating to a user of the mobile electronic device, or information relating to an environment of the user of the mobile electronic device.

17. A personal security system, comprising:
a mobile electronic device,
a panic alarm system comprising a transmitter for wirelessly communicating with the mobile electronic device; and
an application executing on the mobile electronic device configured to receive a wireless signal indicating that the panic alarm system has been actuated.

18. The personal security system of claim 17, wherein the transmitter comprises one of a Near Field Communication transmitter and a Bluetooth® transmitter.

19. The personal security system of claim 17, wherein the panic alarm system is disposed in a cover that is removably attached to the mobile electronic device.

20. The personal security system of claim 19, further comprising a triggering mechanism for actuating the panic alarm system, the triggering mechanism being disposed in a portable object other than the cover.
